(19) United States
(12) Patent Application Publication
(10) Pub. No.: US 2019/0130789 A1
(43) Pub. Date: May 2, 2019

(54) SYSTEM AND METHOD FOR INCREASING FINANCIAL LITERACY

(71) Applicant: Nadia MISHAEL, Los Angeles, CA (US)

(72) Inventor: Nadia MISHAEL, Los Angeles, CA (US)

(21) Appl. No.: 16/179,277

(22) Filed: Nov. 2, 2018

Related U.S. Application Data
(60) Provisional application No. 62/707,439, filed on Nov. 2, 2017.

(51) Int. Cl. G09B 19/18; G06Q 20/40

(52) U.S. Cl. CPC G09B 19/18; G06Q 20/405

(57) ABSTRACT

Disclosed herein are methods of teaching financial literacy to a user, the method comprising the steps of: obtaining access to the user's funds by an automated process; obtaining, through the internet, answers from the user to a plurality of questions regarding the use of funds, wherein the answers are either correct or incorrect; if the number of correct answers is equal to or exceeds a pre-set number, then releasing the funds to the user by an automated process; if the number of correct answers is less than a pre-set number, then denying the funds to the user by an automated process.

### CROSS-REFERENCE TO RELATED APPLICATIONS

The present invention claims the benefit or priority to U.S. Provisional Application No. 62/707,439, filed Nov. 2, 2017, the contents of which are incorporated herein by reference.

### FIELD OF THE INVENTION

The present invention is in the field of methods for teaching financial literacy, and more specifically in the field of software and systems used in such teachings.

### BACKGROUND OF THE DISCLOSURE

It appears that financial literacy is on the decline among the younger generations. Regardless of what has caused this phenomenon, teaching individuals financial literacy at as early an age as possible will result in the development of an interest in financial matters that becomes a life-long habit. However, finance competes with other interests that an individual my find more entertaining. Therefore, there is a need to provide a method of teaching about finance to individual where the method is engaging, interesting, and is based on a reward system.

### SUMMARY OF THE INVENTION

Disclosed herein are methods of teaching financial literacy to a user, the method comprising the steps of: obtaining access to the user's funds by an automated process; obtaining, through the internet, answers from the user to a plurality of questions regarding the use of funds, wherein the answers are either correct or incorrect; if the number of correct answers is equal to or exceeds a pre-set number, then releasing the funds to the user by an automated process; if the number of correct answers is less than a pre-set number, then denying the funds to the user by an automated process.

### DETAILED DESCRIPTION OF THE EMBODIMENTS

Disclosed herein are systems and methods for teaching, or increasing the knowledge of, skills to make individuals better informed of the value of money in day-to-day life. These methods are best suited for children or individuals who have recently attained financial independence, but in reality, any user can find benefit by customizing the protocol and using it to fit their unique situation.

In one broad, but not the broadest, embodiment, the user obtains funds at the beginning of a time period (e.g., daily, weekly, monthly, etc.) and deposits, or has deposited, the funds in a bank account. Based on a previously determined regimen, the bank divides the income among various previously selected uses. For example, X% is allocated for entertainment, Y% is allocated for school supplies, Z% is allocated for clothing, etc. To gain access to the funds, the user must follow a tutorial and pass a quiz at its conclusion. If the user passes the quiz, then the funds are released to them. However, if the user does not pass the quiz, then the funds are denied them, until the next time they take the quiz, which will be at the start of the next time period, e.g., next day, next week, next month, etc.

Thus, in one aspect, disclosed herein is a method of teaching financial literacy to a user, the method comprising the steps of:
obtaining access to the user's funds by an automated process;
obtaining, through the internet, answers from the user to a plurality of questions regarding the use of funds, wherein the answers are either correct or incorrect;
if the number of correct answers is equal to or exceeds a pre-set number, then releasing the funds to the user by an automated process;
if the number of correct answers is less than a pre-set number, then denying the funds to the user by an automated process.

Throughout the present disclosure the term “benefited user” is understood to include the person for whose benefit the methods are employed. An “unbenefited user” is understood to include any other person who is assisting the benefited user. The term “user,” without any modifier, may refer either a single benefited user, or a collective of benefited and unbenefited users. For example, in some steps, the user sets up an account and the user takes a quiz. It is understood that the account is set up by the parent or guardian and the quiz is taken by the child. The present description refers to both of these steps as being performed by the “user.”

In some embodiments, the user is a child who is intending to learn financial responsibility. In other embodiments, the user is an adult, such as a person who has recently become financially independent.

The various steps of the disclosed methods are now described in detail.

The present methods are envisioned to be performed over the internet using the World Wide Web, accessed by a website. Throughout the present disclosure, the “SPG website” refers to the software and processes used in the presently describe methods in addition to the web portal that allows access to the same. “SPG website” can also refer to a smartphone or tablet app that can be used as a portal to the processes used in the presently describe methods.

In some embodiments, the user initially visits the SPG website and registers to start their membership. In certain embodiments, the user is assigned a unique account number.

In some embodiments, the SPG website requires a membership fee to be paid for the user to have continued access to the disclosed methods. The membership fee may be charged monthly, annually, semi-annually, or at other time intervals, or be collected as a one time fee.

In certain embodiments, the administrator of the present methods contacts various financial institutions, e.g., banks, financial management services, etc., in advance to obtain their cooperation with carrying out certain of the steps of the presently disclosed methods. The institutions who agree to cooperate are vetted to see if there is a good match between the institution and the proper performance of the present methods.

In some embodiments, financial institutions wishing to be vetted and featured on the SPG website fill out a secure on-line application form. In certain embodiments, there is a one time vetting fee and/or an annual licensing fee charged to the financial institution. This form optionally includes incentive offers for opening new accounts. Once a financial institution is approved it is given advertising privileges on the SPG website.

In some embodiments, at the time of registration, or at any time afterwards, the user is provided with a list of pre-selected and pre-vetted financial institutions. The user can then choose the financial institution of their choice.

If a particular financial institution is preferred by the user, but the institution does not appear on the pre-vetted list, the user may request the administrator of the SPG website to take the institution through the vetting process. It is understood that more than one financial institution may be associated with the practice of the present methods. For example, one financial institution may be associated with one user account while another institution is associated with another user account.

In some embodiments, the financial institution is the same financial institution where the provider of funds has an account so that funds can be transferred easily between the accounts. In other embodiments, the funds are deposited into the user's account through any of direct deposit, automated programs such as Venmo®, debit card, credit card, or other methods of depositing funds known in the art.

The funds may be deposited once or at various regular time intervals. In some embodiments, the funds are given to the user just once. Examples of these funds include gifts for holidays, birthdays, or graduation, inheritances, proceeds from the sales of an item, and the like.

In other embodiments, the funds are given to the user at regular intervals. For example, the user receives an allowance or a paycheck weekly or biweekly, or receives funds from a pension fund, Social Security, or the like on a monthly basis. These embodiments also include those in which the user sets up an auto-transfer between two separate accounts at the bank. For example, the allowance can be transferred automatically from the parent's account to the child's account, or fund can be transferred from a savings account to a checking account.

In some embodiments, the user is encouraged and reminded to access their SPG website on a regular basis, so as to initiate the education process and reward system. In certain embodiments, the reminder is provided electronically. In some of these embodiments, the reminder is sent by text, e-mail, calendar reminder, or a reminder by a social medium, such as Facebook®, Instagram®, Twitter®, or the like.

In some embodiments, the user takes an initial quiz so the SPG website can determine, based on an applicable algorithm, the initial level of the user's knowledge of the different areas of finance. The educational program for the user is then chosen based on the user's age, level of knowledge, and/or the areas in the initial quiz where the user showed the most deficiency. Thus, in these embodiments, the SPG website creates a database of different categories of educational material, personalized for the particular user. In other embodiments, all users are presented with the same categories of educational material and the user chooses the lesson based on their liking.

In some embodiments, the user gains access to the educational material only after the funds are available to be released to the user, e.g., when a check is deposited or an auto-transfer has occurred. Once the user logs into the educational section of the SPG website, the user faces a number of categories of educational material.

The categories of educational material may include lessons on: banking, budgeting, saving, accruing interest, investing, entrepreneurship, comparing products for quality and price, tax exemptions, tax deductions, decision making, purchasing power, delayed gratification, leveraging funds, spending money responsibly, ways to vet charitable organizations, donating responsibly, social impact, and the like.

In some embodiments, the database is age appropriate and generates an ongoing tiered series of educational lessons, whose function is to ensure a rich playful learning experience. The lessons are tiered in the sense that once a level in a particular category is completed, the user will then be introduced to more complex subjects. The complexity of the subjects increases until the user finishes all the provided lessons. At the conclusion of each lesson, the user is given a quiz that covers the important topics of the particular lesson. If the user passes the quiz, i.e., provides a number of correct answers greater than a pre-set threshold number, then the funds for that time interval are released to the user.

If the user fails the quiz, the funds remain unavailable to the user. In some embodiments, the user may immediately take the quiz again. In other embodiments, the user is required to go through the lesson again before the user is given the chance to take the quiz a second time. In yet other embodiments, the system locks down for a period of time, for example 12 hours or 24 hours, before the user is given the opportunity to take the quiz a second time. In still other embodiments, the user is both required to wait the lock down period and go through the lesson after that period to be able to take the quiz again. In some embodiments, when the user is asked to go through the lesson again, the material is presented with alternate styles of learning (challenges, quizzes, simple games and videos) until the subject matter is mastered. In certain embodiments, the user is unable to access the funds until the next time interval arrives, and the user attempts the quiz again. At that point, the entire sum of money due to the user, that is the sum of both time intervals, will be available to the user.

Once the funds become available to the user, the funds are transferred to their respective accounts

Upon setting up their account on SPG website, the user determines how the funds are going to be distributed depending on their specific needs and wants. For example, the user may decide that 100% of the funds will go to one savings or checking account. Alternatively, the user may decide that, for example, X% will go to savings, Y% will be used for entertainment, and Z% will be used for charitable donation, and so on for other uses, if applicable.

In some embodiments, the user has an account associated with each use, the “use account.” For example, the user may have a savings account, an expense account, a charitable donation account, or other accounts. In concept, there is no maximum number of use accounts that can be set up with the present methods, because there is no maximum number of interests a user may have for which funds are necessary. In practice, however, users will choose a limited number of use accounts that match their particular need or lifestyle, for example 3, 5, 8, or other number of use accounts. Users can add or remove accounts throughout the period of practicing the present methods.

In some embodiments, where a portion of the funds is deposited in the user's savings or a checking account, the user's account may be linked directly, either within the same bank or by bank-to-bank transfer, to the funder's account. In certain embodiments, the user's savings or checking account is used to save money for future need, or for use in entertainment, shopping, school supplies, or any other use the user desires.

Some use accounts may be directly linked with certain third party establishments, such as retailers or charitable organizations. If the funds are to be sent directly to third party establishments, then optionally the administrator of the present methods vets the establishments for their ability to properly comply with the requirements of the present methods.

In some embodiments, the use account is directly linked with a debit card, in-store credit at a retail store, or in-store credit for an online retailer. For example, by linking the use account with the user's amazon.com account, the funds will automatically appear in the user's Amazon® profile as store credits to be used against future purchases.

In some embodiments, the release of funds to each particular use account requires the user to pass a quiz in relation to that particular use. Therefore, in these embodiments, instead of passing a single quiz to have the entire funds be available, the user must pass a plurality of quizzes, one for each use account.

In some embodiments, the release of funds to certain use accounts is conditioned on the successful passing of the quiz for another use account. For example, if the user fails the saving quiz, the passing of the charitable donation quiz will result in the donation being automatically made, the passing of the shopping or entertainment will NOT result in these funds being accessible. This layering of the uses allows the user to learn the relative importance of various expenditures. In the above example, the user will learn that saving one's money is more important than shopping or entertainment and until the user learns satisfactorily how to save their money they will not be allowed to go shopping or to the movies.

In another aspect, disclosed herein are systems that allow the above methods be carried out. The systems include servers on which various databases, such as the educational material database, the user information database, financial data database, and the like, are housed. The servers also house the various software that run the above-described methods.

What is claimed is:

1. A method of teaching financial literacy to a user, the method comprising the steps of:
obtaining access to the user's funds by an automated process; and
obtaining, through the internet, answers from the user to a plurality of questions regarding the use of funds, wherein the answers are either correct or incorrect;
releasing the funds to the user by an automated process if the number of correct answers is equal to or exceeds a pre-set number;
denying the funds to the user by an automated process if the number of correct answers is less than a pre-set number.
